(19) United States
(12) Patent Application Publication
(10) Pub. No.: US 2011/0059185 A1
(43) Pub. Date: Mar. 10, 2011

(54) METHOD FOR IN-PROCESS DECONTAMINATION IN FOOD PREPARATION AND PROCESSING AND FOR REDUCING MICROBIAL CONTENT IN COSMETICS, PHARMACEUTICALS, DAILY-CARE PRODUCTS AND ANIMAL AND PLANT FOOD AND FOR TREATMENT OF SURFACES

(75) Inventors: Michael Saefkow, Weinsberg (DE); Andre Phillipps, Regensburg (DE); Manuel Czech, Donaustauf (DE)

(73) Assignee: Aquagroup AG

(21) Appl. No.: 12/920,014

(22) PCT Filed: Mar. 2, 2009
(86) PCT No.: PCT/EP09/52468

§ 371 Date: Nov. 23, 2010

(30) Foreign Application Priority Data
Feb. 29, 2008 (DE) 10 2008 011 807.9

(51) Int. Cl. A01N 59/00; A01P 15/00

(52) U.S. Cl. 424/600

(57) ABSTRACT

The present invention relates to a novel method for in-process decontamination in food preparation and processing using an aqueous, health-wise non-hazardous cleaning medium. The invention further relates to a method for treating surfaces and for reducing the microbial content with an aqueous, health-wise non-hazardous medium which is more effective than conventional cleaning media.

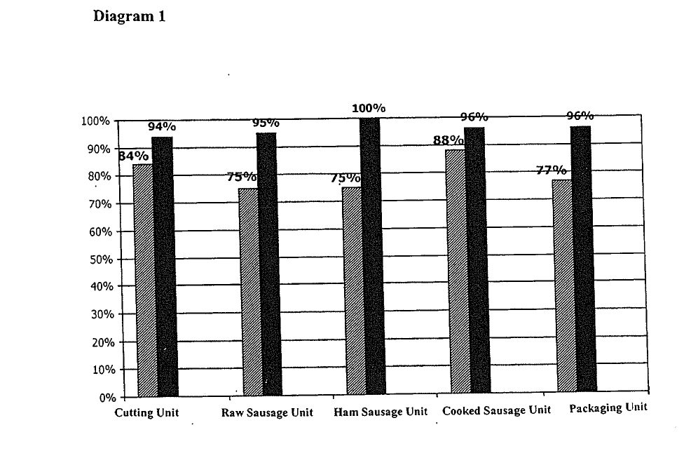

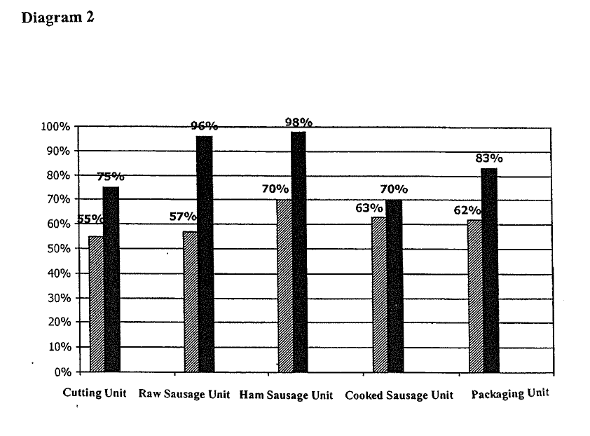

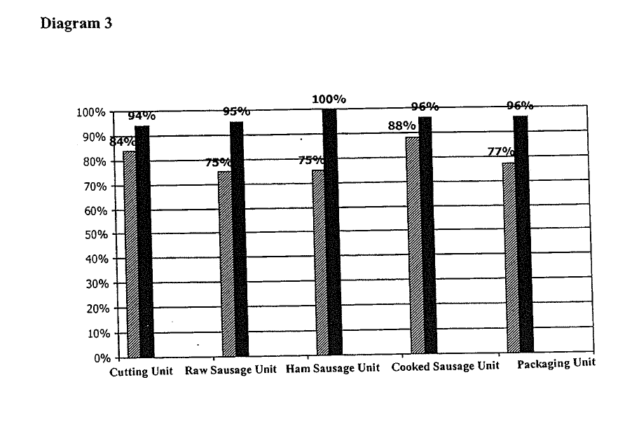

### FIELD OF INVENTION

The present invention relates to a method for in-process decontamination of installations in the food industry, in particular in food preparation and processing. It furthermore relates to a method for the treatment of surfaces and for reducing the microbial content also on the foodstuffs themselves.

### GENERAL STATE OF THE ART

Transport and processing plants for food, as well as the food disposed thereon, are exposed, from the raw product to the end product, to constant contamination by microorganisms such as bacteria, viruses, fungi and algae. This involves the risk of carrying along dirt and germs from the raw product into the clean area and onto the end product, so that regular cleaning, disinfection and decontamination of various parts of the processing plants are essential.

However, the disinfectants normally used for these purposes, based on alcohols, aldehydes, halogens, halogen amines, hypochlorite/chlorine, peracids, quaternary ammonium compounds (QAC) and other synthetic agents constitute a health hazard and require the stoppage of production for cleaning purposes, followed by multiple rinsing steps. This results in economic disadvantages due to the interruption of production and high water consumption. In addition, the reduction regarding the microbial content by conventional agents is often inadequate.

It is the object of the present invention to overcome the drawbacks of the state of the art with regard to decontamination of transport and processing plants in the food industry, as well as of foodstuffs themselves. Moreover, improved methods are to be provided for a particularly effective reduction of the microbial content in cosmetics, pharmaceuticals, daily care products and foodstuffs, as well as for the treatment of surfaces.

### BRIEF SUMMARY OF THE INVENTION

This object is attained by a method for the in-process decontamination of food and transport and processing plants for food, comprising the bringing into contact the transport and processing plants and the food with an aqueous, healthwise non hazardous cleaning medium. Moreover, according to a further feature of the invention, a method is provided for reducing the microbial content in cosmetics, pharmaceuticals, daily care products and food with an aqueous, healthwise non hazardous cleaning medium. Furthermore, a method is provided for the treatment of surfaces, involving bringing the surface into contact with an aqueous, healthwise non hazardous cleaning medium which at a concentration of active substances of e.g. 3.5 vol. % is more effective than conventional cleaning media, such as e.g. 85% ethanol.

The method of the present invention is characterized by the use of a disinfecting cleaning medium which is preferably nonirritating, non corrosive, nontoxic and non mutagenic, i.e. which is healthwise non hazardous, does not leave any residues, is gentle on materials due to pH-neutrality and, in addition, is taste- and odorless. The methods according to the invention result in a microbial reduction of up to 5 log counts in bacteria, viruses, prions, fungi and various types of algae.

The method for cleaning and disinfecting of food transport and food processing plants and foodstuffs disposed thereon is an in-process decontamination method, i.e. due to the above-described properties of the cleaning medium cleaning and decontamination of these plants may be performed in the course of their operation. Such methods are not known in the state of the art.

### DETAILED DESCRIPTION OF THE INVENTION

The method according to the invention for in-process decontamination of food and transport and processing plants for food comprises bringing the transport and processing plants and the food into contact with an aqueous, healthwise non hazardous cleaning medium.

In a preferred embodiment the said method for in-process decontamination is used for processing and transporting poultry, fish, pork and beef.

This involves cleaning and decontamination of conveyor belts for poultry, pig and cattle slaughtering, cutting up of fish, poultry, beef and pork and processing fish poultry, beef and pork. The aforesaid method relates likewise to the cleaning and decontamination of machine parts of machines and tools such as knives and cutting robots for cutting up and processing fish, poultry, beef and pork, such as foot hooks and intestinal drills for poultry slaughtering and processing, filleting machines for fish processing, special machines for tripe processing, machines for raw sausage processing, slicers, cutters, whip equipment for removing bristles from the slaughtered pig and packaging machines for poultry, fish, beef and pork products, transport containers, troughs, mixing installations, agitators, agitating mechanisms, knives, continuous cooling plants, deep-fryers as well as all appliances and ancillary equipment which come into contact with food.

In a further preferred embodiment, the aforesaid method for in-process decontamination is used for processing and transporting plant-based food such as vegetables, salads, fruit, nuts, cereals and spices. Transport installations, washing installations, cutting installations, portioning devices, spice mills and other mills, packaging installations as well as tools and appliances for processing, assembling and preparing may be cleaned and disinfected by this method.

The method according to the invention comprises the continuous cleaning and disinfection of slaughter and processing plants in the course of their operation, as well as the concomitant decontamination of poultry, meat and fish products. Previously installed water jets such as e.g. water jets in fish filleting machines may be retrofitted so that they contain an aqueous, healthwise non hazardous cleaning medium.

The healthwise non hazardous cleaning medium is sprayed at ambient temperature. By “healthwise non hazardous” it is understood that intake of the cleaning medium by humans does not constitute a more significant health hazard than the intake of normal, clean water, such as tap or mineral water.

Since the cleaning medium is healthwise non hazardous, it may be used and come into contact with the foodstuffs during operation of the aforesaid transport and processing plants. Stoppage of production for the purpose of decontamination of the plants and rinsing of the plants following the decontamination step in order to remove cleaning medium residues is unnecessary, since after application, the medium is healthwise entirely non hazardous, taste- and odorless.

According to a further aspect of the invention, a method is claimed for reducing the microbial content in cosmetics, pharmaceuticals, daily care products and foodstuffs by means of an aqueous, healthwise non hazardous cleaning medium. One field of application comprises mixing installations, filling lines and containers for the production of shower gels, tooth pastes and soaps in the cosmetic sector.

A further method according to the invention is a method for the treatment of surfaces comprising bringing the surface into contact with an aqueous, healthwise non hazardous cleaning medium, the said cleaning medium at a concentration of active substances of e.g. 3.5 vol. % being more effective than conventional cleaning media, such as e.g. 85% ethanol.

The healthwise non hazardous cleaning medium used in the method for in-process decontamination, in the method for reducing the microbial content and in the method for the treatment of surfaces is a disinfecting cleaning medium.

A cleaning medium is referred to as disinfecting, if the rate of removal of microorganisms such as Enterococcus hirae, except fungi, is at least 5 log counts, i.e. that per 100 000 of microorganisms present, at the most one microorganism remains after application of the disinfecting cleaning medium. In the case of fungi such as Candida albicans the rate of removal needs to be at least 4 log counts in order to allow a cleaning medium to be called disinfecting.

The disinfecting cleaning medium used preferably contains a mixture of water and cleaning concentrate. Such concentrates, if stored in a sealed and light-protected container, may be stored over an extended period of time.

In the method according to the invention the aforesaid cleaning medium contains between 0.1 vol. % and 100 vol. % of the cleaning concentrate.

A preferred embodiment of the present inventions comprises methods, wherein the disinfecting cleaning medium, at a concentration of 5 vol. %, brings about a reduction of the microbial load by Enterococcus hirae exceeding 5 log counts within 5 minutes. A particularly preferred embodiment of the present inventions comprises methods, wherein the aforesaid cleaning medium at a concentration of 5 vol. % brings about a reduction of the microbial load by Enterococcus hirae exceeding 5 log counts within one minute. In a particularly preferred embodiment of the present inventions methods are included wherein the aforesaid cleaning medium at a concentration of 5 vol. % brings about a reduction of the microbial load by Enterococcus hirae exceeding 5 log counts within 30 seconds.

The disinfecting cleaning medium used in the methods of the invention has a pH value of 2.0 to 8.0 and a redox potential of +300 mV to +1200 mV. In a particularly preferred embodiment of the invention the disinfecting cleaning medium has a pH value of 7.0.

The cleaning medium used in the methods according to the invention may comprise anolytes selected from the group of ClO., ClO⁻, HClO, OH., HO₂⁻, H₂O₂, O₃, S₂O₈²⁻, Cl₂, Cl., HO₂., O₂, O₂., 3O₂, 1O₂, O., H₃O, H., Cl₂O, ClO₂, HCl, Cl₂O₇, H₂SO₄ and HSO₃Cl. The anolyte content of the cleaning concentrate contained in the cleaning medium in this context amounts to 100 to 600 ppm.

Preferably, the cleaning concentrate is one which is commercially available under the trade name NADES (concentrate) (aquagroup AG, Regensburg, Germany). NADES (concentrate) contains approximately 99.98% water and about 0.02% (200 ppm) oxidizing agent, in particular sodium hypochlorite (<200 ppm) at pH≈7.0.

NADES (concentrate) may, in exceptional cases, constitute up to 100 vol. %, more frequently up to 50 vol. % of the cleaning medium, while the remaining 50 vol. % of the medium are water. Generally, however, water is added to 0.1 to 10 vol. % of NADES (concentrate).

In an alternative, preferred embodiment the cleaning concentrate is the one which is commercially available under the trade name NADES Naturale (concentrate) (aquagroup AG, Regensburg, Germany), which is substantially free of oxidizing agents.

Moreover, the method for in-process decontamination of food and/or transport and processing plants for food may, in addition, comprise the bringing into contact of these plants and/or food with an aqueous, basic cleaning medium.

The aforesaid, aqueous basic cleaning medium is healthwise non hazardous and contains preferably a mixture of water and cleaning medium concentrate. Preferably, the basic cleaning agent concentrate constitutes between 0.1 and 100% of the basic cleaning agent.

In the method according to the invention for in-process decontamination of transport and processing plants for food, the aforesaid basic cleaning agent is used in combination with NADES (concentrate) or a dilution of NADES (concentrate) for thermophilic spore control. Moreover, it increases the wettability of plants contaminated by fat or oil.

The aforesaid basic cleaning agent has a pH value ranging from 7 to 13 and a redox potential ranging from −200 mV to −1100 mV, preferably of −800 mV. It comprises catholytes selected from the group of OH⁻, H₃⁻, O₂, H₂, HO₂, HO₂⁻ and O₂⁻. The catholyte content of the basic cleaning agent concentrate does not exceed 100 to 1500 ppm.

In a preferred embodiment the basic cleaning agent concentrate used in the method for in-process decontamination is the one which is commercially available under the trade name NADES Base (concentrate) (aquagroup AG, Regensburg, Germany).

NADES Base (concentrate) contains, besides water, 880 ppm (0.088%) NaOH as total alkalinity and, apart from other reducing species, may contain nitrite (14.79 ppm), chloride (11.70 ppm), phosphate (11.48 ppm), sulfate (7.89 ppm), nitrate (1.14 ppm), sodium (439.00 ppm) and potassium (3.60 ppm). Due to the low NaOH content (0.088%), it is impossible for NADES Base to cause any risk to humans, animals or the environment. For this reason, NADES Base is also not included in the hazardous substances ordinance.

NADES Base (concentrate) may be used at concentrations of up to 100%, but for cleaning purposes is generally added to ordinary water at 0.1 to 70%.

In special cases NADES and NADES Base may also be used consecutively in combination with one another.

Rinsing with NADES (concentrate) or its dilutions in water is advantageous after prior application of cleaning agents containing NADES Base, in particular in the case of contamination by obstinate microorganisms.

### EXAMPLES

### Efficacy

Performing of a Laboratory Test with Nades

A microbial suspension with microbes washed only three times is prepared, one milliliter of this suspension being added to and mixed with 5 ml of an appropriate NADES dilution (30, 10, 5, 3, 2, 1 or 0.5 vol. %). The period of time during which this bacterial suspension-NADES mixture acts is at least 10 seconds before 5 ml of a casein-soy nutrient medium (CSL) or of a casein-soy nutrient medium (CSL) with dextrose was added for deactivating NADES.

This mixture is mixed and incubated until distinct colonies were formed and these are counted in order to measure the reduction performance.

Laboratory Tests According to the Guidelines of the Deutsche Gesellschaft für Krankenhaushygiene (DGHK) [German Society for Hospital Hygiene]

Testing for the efficacy of a disinfectant according to the guidelines of the German Society for Hospital Hygiene (DGHK) is performed with defined strains of the bacteria Staphylococcus aureus (ATCC 6538), Enterococcus hirae (ATCC 10541), Pseudomonas aeruginosa (ATCC 15442) and the fungus Candida albicans (ATTCC 10231). After adding a disinfectant to the respective microbial suspension, reductions of the microbial content of the microbial suspensions by 5 log counts, or reductions of the microbial content of the fungus suspension by 4 log counts need to take place within 15 or 30 minutes in order to meet the requirements of the DGHK guidelines.

In Tables 1 to 4 hereafter the effect of NADES solutions of various concentrations on the respective microbial test solutions is shown. All tests were performed in the absence of protein (without load). The starting suspensions of S. aureus (Table 1), E. hirae (Table 3), P. aeruginosa (Table 2) and C. albicans (Table 4) involved concentrations of 9.23 log CFU/ml [Colony-Forming Units/ml], 9.25 log CFU/ml, 9.46 log CFU/ml or 8.67 log CFU/ml, respectively. NADES solutions at 5, 10 and 30% concentrations were added to the starting suspensions. After in each case 30 seconds, one minute and 5 minutes the samples were tested for their microbial count (log CFU/ml). These values of the microbial counts are furthermore shown in all tables as log reduction factors after 30 seconds, one minute and 5 minutes.

In all four test series three control solutions were prepared. Control 1 is a suspension of the respective microbe, to which water of standardized hardness was added instead of a NADES solution. After 30 seconds, one minute and 5 minutes the microbial counts remained constant in all microbial test solutions and were reduced only by the dilution with water. Control 2 shows the neutralization of NADES solution by a casein-soy nutrient medium. For this purpose 1 ml of the microbial suspension was mixed with 1 ml of a 30% NADES solution. After a reaction time of 10 seconds, 8 ml CSL [casein soy solution] were added to this mixture. The microbial count in log CFU/ml was determined after 5 minutes, showing that although reduced, these, due to the neutralization of the NADES solution, were higher after 5 minutes than in test solutions, in which the NADES solution had not been deactivated. Control 3 was performed in order to show that CSL has no toxic effect on the microbes and that such an effect in control 2 can be attributed only to the effect of the NADES solution. One milliliter of microbial suspension was mixed with one milliliter of water of standardized hardness and 8 ml CSL. The microbial count of the solution was measured in CFU/ml after 5 minutes.

In the case of S. aureus a 5% NADES solution is able to reduce the microbial count of the starting solution by more than 5 log counts within 5 minutes. With a 10% NADES solution this effect sets in after one minute and with a 30% solution after 30 seconds already.

TABLE 1
S. aureus

| | Microbial count | | | Lg-reduction | | |
|---|---|---|---|---|---|---|
| | (log CFU/ml) after | | | factors after | | |
| Concentration % | 30 sec. | 1 min | 5 min | 30 sec. | 1 min | 5 min |
| 5 | >5.48 | 1.86 | 1.34 | <1 | 4.97 | 5.48 |
| 10 | 1.87 | <1 | <1 | 4.94 | >5.83 | >5.82 |
| 30 | <1 | <1 | <1 | >5.81 | >5.83 | >5.82 |
| Control 1 | 6.81 | 6.83 | 6.82 | | | |
| Control 2 | | | 3.61 | | | |
| Control 3 | | | 4.22 | | | |

In a P. aeruginosa starting solution the bactericidal effect of a 5 or 10% NADES solution with regard to microbial reduction by more than 5 log counts appears after 5 minutes in the respective case. A 30% NADES solution attains the same success in a P. aeruginosa starting solution after 30 seconds already.

TABLE 2
P. aeruginosa

| | Microbial count | | | Lg-reduction | | |
|---|---|---|---|---|---|---|
| | (log CFU/ml) after | | | factors after | | |
| Concentration % | 30 sec. | 1 min | 5 min | 30 sec. | 1 min | 5 min |
| 5 | 3.91 | 4.43 | 1.26 | 2.89 | 2.39 | 5.57 |
| 10 | 2.54 | 3.67 | 0.30 | 4.26 | 3.15 | 6.53 |
| 30 | <1 | <1 | <1 | >5.80 | >5.82 | >5.83 |
| Control 1 | 6.80 | 6.82 | 6.83 | | | |
| Control 2 | | | 3.78 | | | |
| Control 3 | | | 4.76 | | | |

In S. aureus as well as in P. aeruginosa 5 to 30% NADES solutions surpass the requirements of the DGHK guidelines. This effect is, however, particularly clear in E. hirae. 5, 10 and 30% NADES solutions are in this case able to bring about a microbial reduction by more than 5 log counts in only 30 seconds. As far as E. hirae is concerned, such an effect in other disinfectants known from the state of the art is not known.

TABLE 3
E. hirae

| | Microbial count | | | Lg-reduction | | |
|---|---|---|---|---|---|---|
| | (log CFU/ml) after | | | factors after | | |
| Concentration % | 30 sec. | 1 min | 5 min | 30 sec. | 1 min | 5 min |
| 5 | 1.20 | <1 | <1 | 5.53 | >5.75 | >5.70 |
| 10 | 1.04 | <1 | <1 | 5.69 | >5.75 | >5.70 |
| 30 | <1 | <1 | <1 | >5.73 | >5.75 | >5.70 |
| Control 1 | 6.73 | 6.75 | 6.70 | | | |
| Control 2 | | | 3.65 | | | |
| Control 3 | | | 4.11 | | | |

A microbial reduction by more than 4 log counts was obtained after treating a starting solution of the fungus C. albicans with a 10% NADES solution after one minute and with a 30% NADES solution after 30 seconds. The effect of NADES solutions, in this case as well, surpasses the requirements of the DGHK-guidelines.

TABLE 4
Candida albicans

| | Microbial count | | | Lg-reduction | | |
|---|---|---|---|---|---|---|
| | (log CFU/ml) after | | | factors after | | |
| Concentration % | 30 sec. | 1 min | 5 min | 30 sec. | 1 min | 5 min |
| 5 | 4.83 | 2.25 | 1.83 | 0.71 | 3.28 | 3.68 |
| 10 | 1.76 | <1 | <1 | 3.78 | >4.53 | >4.51 |
| 30 | <1 | <1 | <1 | >4.54 | >4.53 | >4.51 |
| Control 1 | 5.54 | 5.53 | 5.51 | | | |
| Control 2 | | | 3.78 | | | |
| Control 3 | | | 4.76 | | | |

Laboratory Tests According to the Guidelines of the Deutsche Veterinärgesellschaft (DVG) [German Veterinary Society]

The guidelines of the German Veterinary Society (DVG) regarding the efficacy of disinfectants provide that the strains of the bacteria Staphylococcus aureus (DSM 799), Enterococcus faecium (DSM 7918), Proteus mirabilis (DSM 788), Pseudomonas aeruginosa (ATCC 15442), as well as of the fungus Candida albicans (ATCC 10231) are reduced by 5 log counts within 15 minutes or 30 minutes at application temperatures of 20° C. and 10° C. respectively.

Table 5 shows the test results for all 5 test strains cited above (109 CFU/ml), without protein, at 10° C. The starting solutions of a respective microbe was treated with a 0.5, 1, 2, 3, 5, 10 and 30% NADES solution. Two samples each of each strain were prepared at a determined concentration of the NADES solution and tested for their microbial count content after 5, 15, 30 and 60 minutes. A minus sign in the Table indicates the complete destruction of the microbe. Two control tests were performed for each test strain. Controls 1 contained merely the respective microbe and water of standardized hardness, showing microbial growth, as was to be expected. Controls 2 contained 1% phenol or, respectively, 3% formalin and showed no microbial growth.

The best result was attained for E. faecium. A 1% NADES solution was able in this case to kill all microbes of the sample within 5 minutes. For S. aureus and C. albicans a 2% NADES solution was necessary in order to obtain the same effect. A 3% NADES solution killed all microbes of P. mirabilis and P. aeruginosa within 5 minutes. This reduction performance has never been attained in the state of the art.

TABLE 5
Results at 10° C.

| | | | | 15 | | 30 | | 60 | |
|---|---|---|---|---|---|---|---|---|---|
| | | 5 min | | min | | min | | min | |
| Test strains | Concentration % | I | II | I | II | I | II | I | II |
| Staphylococcus | 0.5 | + | + | + | + | − | + | − | + |
| aureus | 1.0 | + | + | + | − | − | − | − | − |
| | 2.0 | − | − | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Enterococcus | 0.5 | + | + | − | − | − | − | − | − |
| faecium | 1.0 | − | − | − | − | − | − | − | − |
| | 2.0 | − | − | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Proteus | 0.5 | + | + | + | + | − | + | − | + |
| mirabilis | 1.0 | + | + | − | + | − | + | − | + |
| | 2.0 | + | + | − | + | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Pseudomonas | 0.5 | + | + | + | + | − | + | − | − |
| aeruginosa | 1.0 | + | + | − | + | − | − | − | − |
| | 2.0 | + | + | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Candida | 0.5 | + | + | + | + | + | − | − | − |
| albicans | 1.0 | + | + | − | − | − | − | − | − |
| | 2.0 | − | − | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |

Table 6 represents the results of all 5 test strains cited above, without protein, at 20° C. NADES solutions were used at the concentrations described for Table 5 and two samples each of a specific strain with the respective NADES solution were tested for their microbial count after 5, 15, 30 and 60 minutes. After as little as 5 minutes after treatment with a 1% NADES solution E. faecium could no longer be detected. The same effect was also observed for S. aureus and P. mirabilis with a 2% NADES solution after 5 minutes. A 1 to 3% or 5 to 10% NADES solution, respectively, was necessary to destroy all P. aeruginosa and C. albicans microbes within 5 minutes. This reduction performance has never been attained in the state of the art.

TABLE 6
Results at 20° C.

| | | | | 15 | | 30 | | 60 | |
|---|---|---|---|---|---|---|---|---|---|
| | | 5 min | | min | | min | | min | |
| Test strains | Concentr. % | I | II | I | II | I | II | I | II |
| Staphylococcus | 0.5 | + | + | + | + | − | + | − | + |
| aureus | 1.0 | − | + | − | − | − | − | − | − |
| | 2.0 | − | − | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Enterococcus | 0.5 | − | + | − | + | − | + | − | + |
| faecium | 1.0 | − | − | − | − | − | − | − | − |
| | 2.0 | − | − | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Proteus | 0.5 | + | + | + | + | − | + | − | − |
| mirabilis | 1.0 | + | + | − | + | − | − | − | − |
| | 2.0 | − | − | − | − | − | − | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Pseudomonas | 0.5 | + | + | + | + | + | + | + | + |
| aeruginosa | 1.0 | + | + | + | + | + | − | − | − |
| | 2.0 | + | + | + | − | + | − | − | − |
| | 3.0 | + | − | − | − | + | − | − | − |
| | 5.0 | − | − | − | − | + | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |
| Candida | 0.5 | + | + | − | − | − | + | − | − |
| albicans | 1.0 | − | − | − | − | − | + | − | − |
| | 2.0 | − | − | − | + | − | + | − | − |
| | 3.0 | − | − | − | − | − | − | − | − |
| | 5.0 | − | − | − | − | − | − | − | − |
| | 10 | − | − | − | − | − | − | − | − |
| | 30 | − | − | − | − | − | − | − | − |
| | Control 1 | + | | + | | | | | |
| | Control 2 | − | | − | | | | | |

### Nightly Cleaning or Disinfection of Floors and Appliances for Pork Cutting and Processing

The attached diagrams 1 and 2 reflect the percentage results of imitation tests for the reduction of the general microbial content in the unit 1 CFU per 10 cm² or 10 CFU per 10 cm² respectively of various appliances for pork cutting and processing, as well as of the floors on which these appliances stand, after nightly cleaning or disinfection. Comparisons are made between the use of a conventional, DVG-listed disinfectant which corresponds to the state of the art, and the use of a 3.5% NADES solution. In this context, the grey columns represent the results of the conventional agent and the black columns those of the NADES solution. From the left to the right, the column pairs represent floors and associated cutting appliances, floors and/or associated appliances for raw sausage processing, floors and associated appliances for the preparation of ham sausage (SSP), floors and associated appliances for the preparation of cooked sausages (PSP) and floors and associated packaging machines for meat products and meat/sausage spreads.

Diagram 1 shows the respective percentage number of the non objectionable imitation tests (daily control of nightly cleaning over several weeks) at a microbial contamination tolerance threshold of 1 CFU per 10 cm². All appliances and floors tested show a clear microbial reduction when cleaned nightly with a 3.5% NADES solution. In comparison with the conventional disinfectant, improvements of the microbial reduction between 7 and about 40% were attained. For the appliances for raw sausage processing and ham sausage preparation, as well as for the associated floors, it was possible to attain a reduction to 4% or 2%, respectively, of the samples exceeding 1 CFU per 10 cm². These values amount to 43% and 30%, respectively, when using a conventional agent.

Diagram 2 shows the respective percentage number of the non objectionable imitation tests (daily control of nightly cleaning over several weeks) at a microbial contamination tolerance threshold of 10 CFU per 10 cm². At this increased tolerance threshold both disinfectants showed increased efficacy; however, the efficacy of the NADES solution in relation to the appliances for raw sausage processing and packaging machines, as well as the associated floors was about 20% higher than that of the conventional agent. When using NADES solutions for the nightly cleaning of appliances for raw sausage processing, ham sausage- and cooked sausage preparation and of appliances for meat packaging, as well as of the associated floors, the number of samples exceeding the tolerance threshold of 10 CFU per 10 cm² were at the most 2%.

Diagram 3 shows the percentage results of imitation tests for the reduction of the infestation by the faecal bacteria Enterobacteriaceae in the unit CFU per 10 cm² after nightly disinfection. As described above for Diagrams 1 and 2, the grey columns represent the results of the conventional agent and the black columns those of the NADES solution. From left to right the column pairs represent floors and associated cutting devices, floors and associated appliances for raw sausage processing, floors and associated appliances for the preparation of ham sausage (SSP), floors and associated appliances for the preparation of cooked sausage (PSP) and floors and associated packaging machines for meat products. In comparison with the DVG-listed disinfectant, it was possible to improve the reduction of Enterobacteriaceae by about 10 to 30% with the aid of the NADES solution. The percentage of microbe-free samples for all five appliance types and associated floors was between 94 and 100%.

Table 7 shows the total microbial content, including healthwise non hazardous microbes, in CFU/cm² and the content of Enterobacteriaceae in CFU/cm² prior to and after nightly cleaning of special machines for tripe processing with a 3.5% NADES solution. Sampling was performed by imitation tests of the ascending tripe conveyor belt, cutting table, cutting device, tripe cutter, cutter, tripe conveyor belt, Handtmann table, Handtmann funnel, the wall and the evaporator.

After nightly cleaning with the NADES solution most of the machine parts were entirely sterile, in particular the evaporator and the cutter, having previously shown values of the total microbial content exceeding 1000 CFU/cm² or exceeding 100 CFU/cm², respectively. The tripe conveyor belt which had been covered with a germ film prior to treatment with the NADES solution exhibited only a total microbial content of 1 CFU/cm² after treatment with the NADES solution. Imitation tests of Enterobacteriaceae showed that only in one case a value of 1 CFU/cm² was measured. All other samples were entirely free from Enterobacteriaceae after nightly treatment with a 3.5% NADES solution.

TABLE 7

| | | | Entero- | |
|---|---|---|---|---|
| | | | bacteriaceae | Entero- |
| | Total microbial | Total microbial | (CFU/cm²) | bacteriaceae |
| Location of | count (CFU/cm²) | count (CFU/cm²) | prior to | (CFU/cm²) |
| sampling | prior to NADES | after NADES | NADES | after NADES |
| Ascending | 12 | 1 | 7 | 0 |
| tripe conveyor | | | | |
| belt | | | | |
| Cutting table | 30-100 | 0 | 31 | 1 |
| Cutting device | 30-100 | 5 | 22 | 0 |
| Tripe cutter | 30-100 | 0 | 40 | 0 |
| Cutter | Exceeding 100 | 0 | 24 | 0 |
| Tripe conveyor | Film | 1 | Exceeding 100 | 0 |
| belt | | | | |
| Handtmann | 9 | 2 | 1 | 0 |
| Table | | | | |
| Handtmann | 30-100 | 0 | 2 | 0 |
| Funnel | | | | |
| Wall | 30-100 | 0 | 28 | 0 |
| Evaporator | Exceeding 100 | 0 | 31 | 0 |

### In-Process Decontamination in Salmon Processing

Table 8 shows test results of 1 g and 25 g salmon samples on Listeria monocytogenes after treatment with a 3.5% NADES solution. The first seven columns contain the values measured for smoked salmon, the last three columns marked “salmon” refer to the values measured for packaged salmon. Prior to using NADES, the values for the microbial content of all 25 g samples and more than half of all 1 g samples were 105 CFU/g to 107 CFU/g. After treatment with NADES all 1 g samples and the major portion of the 25 g samples were considered germ-free. All batches therefore meet the requirements for the microbial content with regard to the 1 g samples in Germany and the requirements in France and Italy with regard to the 25 g samples.

TABLE 8

| | | | | | Salmon | | | | | |
|---|---|---|---|---|---|---|---|---|---|---|
| | Salmon | Salmon | Salmon | Salmon | after | Salmon | Salmon after | | | |
| Sample | after | after | after | after | smoking | after | curing | | | |
| type | smoking | smoking | smoking | smoking | (Denner) | smoking | (Denner) | Salmon | Salmon | Salmon |
| 25 g | neg | neg | neg | neg | neg | neg | neg | 1x pos | neg | 4x pos |
| Listeria | | | | | | | | | | |
| 1 g | neg | neg | neg | neg | neg | neg | neg | neg | neg | neg |
| Listeria | | | | | | | | | | |
| CFU/g | <10 × 102 | <10 × 102 | <10 × 102 | <10 × 102 | <10 × 102 | <10 × 102 | <10 × 102 | | | |
| 25 g | 3x pos | | | 3x pos | neg | 2x pos | neg | | | |
| Listeria | | | | | | | | | | |
| 1 g | neg | | | neg | neg | neg | neg | | | |
| Listeria | | | | | | | | | | |
| CFU/g | <10 × 102 | | | <10 × 102 | <10 × 102 | <10 × 102 | <10 × 102 | | | |

### Toxicity Tests

### Toxicological Test Results for NADES

For the assessment of the toxicological potency of NADES for humans, and a potential wastewater risk, extensive in vitro bio-tests were performed for acute and chronic toxicity, phytotoxicity and mutagenicity.

### Acute Toxicity

Cells of mice (murine fibroblasts) tolerated a concentration of 10% NADES for a duration of up to 60 minutes at 100% vitality and even after 180 minutes still maintained vitality exceeding 80% (acute tissue toxicity test on peritoneal tissue of rats in the explant test and acute cytotoxicity test on murine fibroblasts using the neutral red method according to DIN EN 30993-5 (1994)). Short-term, i.e. for 10 minutes, a concentration of 25% was tolerated. Human amnion cells tolerate a concentration of 10% for 10 minutes and a concentration of 2% for 180 minutes (acute cytotoxicity test on human amnion cells using the neutral red method according to DIN EN 30993-5 (1994)). The maximum concentration is guided by these data, depending on indication and reaction time.

### Chronic Toxicity

The data of tests for chronic toxicity (reaction time 24 hours), i.e. chronic luminous bacteria tests using Vibrio fischeri according to DIN EN ISO 38412-37 (1999), chronic cytotoxicity test on murine fibroblasts using the neutral red method according to DIN EN 30993-5 (1994), chronic cytotoxicity test on human amnion cells using the neutral red method DIN EN 30993-5 (1994) and chronic tissue toxicity test on peritoneal tissue of rats in the explant test, indicate a to tolerance for a 2% NADES solution.

### Mutagenicity

According to the Mutatox® geno-toxicity-/mutagenicity test using the non-luminous mutant M169 of Vibrio fischeri according to MACHEREY-NAGEL there is no indication of mutagenicity of NADES.

### Phytotoxicity

The luminous bacteria test (acute luminous bacteria test using Vibrio fischeri according to DIN EN ISO 11348-2 (1998) and the phytotoxicity test on duckweed Lemna minor (according to ISO TC 147/SC 5 N (draft 2001) indicate compatibility of NADES at concentrations <2% in relation to the toxicity in wastewater.

Based on the test results on eukaryotic cells NADES may be classified as well-tolerated at a concentration of <2%, both short-term as well as with a 24-hour application. The results of the tissue explant test indicate that under practice-orientated conditions a higher concentration of up to 10% may be considered as non hazardous. The results of the genotoxicity test do not reflect a mutagenic potential of NADES. However, the good tolerance at concentrations below 2%, as well as the anti-microbial efficacy, even when diluted to 1:10 5, indicate an applicability in this range of concentration. Eco-toxicological safety of NADES concentrations of <2% is apparent from the luminous bacteria test and the phytotoxicity test.

1. Use of an aqueous, healthwise non hazardous cleaning medium for in-process decontamination of food and transport and processing plants for food by bringing into contact the transport and processing plants and/or food with the aqueous, healthwise non hazardous cleaning medium, the food being poultry and/or fish and/or pork and/or beef and/or plant-based food, preferably vegetables, salads, fruit, nuts or cereals, and the cleaning medium being a disinfecting cleaning medium containing a mixture of water and cleaning concentrate, the cleaning medium comprising analytes selected from the group of ClO., ClO⁻, HClO, OH., HO²⁻, H₂O₂, O₃, S₂O₈²⁻, Cl₂, Cl., HO₂., O₂, O₂., 3O₂, 1O₂., O., H₃O, H., Cl₂O, ClO₂, HCl, Cl₂O₇, H₂SO₄ and HSO₃Cl and the cleaning medium having a pH value ranging from 2.0 to 8.0 and a redox potential ranging from 300 to 1200 mV and the disinfecting cleaning medium being nonirritating, non corrosive, nontoxic and non mutagenic.

2. Method according to claim 1, characterized in that it involves conveyor belts and other machine parts of transport and processing plants, preferably knives and agitating devices.

3. (canceled)

4. Method for treating surfaces comprising bringing the surface into contact with an aqueous, healthwise non hazardous cleaning medium, the said cleaning medium at a concentration of 3.5% being more effective than conventional cleaning media such as alcohols, aldehydes, peracids, halogens, halogen amines and quaternary ammonium compounds.

5. Method according to claim 4, wherein the cleaning concentrate constitutes between 0.1 vol. % and 100 vol.% of the cleaning medium.

6. Method according to claim 1, wherein the said cleaning medium at a concentration of 5 vol. % brings about a reduction of the microbial contamination by Enterococcus hirae exceeding 5 log counts within 5 minutes.

7. Method according to claim 6, wherein the said cleaning medium at a concentration of 5 vol. % brings about a reduction of the microbial contamination by Enterococcus hirae exceeding 5 log counts within one minute.

8. Method according to claim 5, wherein the said cleaning medium at a concentration of 5 vol. % brings about a reduction of the microbial contamination by Enterococcus hirae exceeding 5 log counts within 30 seconds.

9. Method according to claim 1, wherein the said cleaning medium has a pH value of 7.0.

10. Method according to claim 9, wherein the cleaning concentrate contained, in the cleaning medium has an anolyte content not exceeding 100 to 600 ppm.

11. Method according to claim 9, wherein the cleaning concentrate contained in the cleaning medium is NADES (concentrate).

12. Method according to claim 1, wherein the method further includes bringing into contact the transport and processing plants and/or foods with a basic, aqueous cleaning agent.

13. Method according to claim 12, wherein the basic, aqueous cleaning agent comprises a mixture of water and basic cleaning agent concentrate.

14. Method according to claim 12, wherein the basic cleaning agent concentrate constitutes between 0.1 and 100% of the basic cleaning agent.

15. Method according to claim 12, wherein the basic cleaning agent in combination with NADES (concentrate) or a dilution of NADES (concentrate) is effective against thermophilic spores.

16. Method according to claim 12, wherein the basic cleaning agent has a pH value ranging from 7 to 13 and a redox potential ranging from −200 mV to −1100 mV.

17. Method according to claim 12, wherein the basic cleaning agent has a redox potential of −800 mV.

18. Method according to claim 12, wherein the basic cleaning agent comprises catholytes selected from the group of OH⁻, H₃⁻, O₂, H₂, HO₂, HO₂⁻ and O₂⁻.

19. Method according to claim 13, wherein the basic cleaning agent has a catholyte content not exceeding 100 to 1500 ppm.

20. Method according to claim 13, wherein the basic cleaning agent concentrate is NADES Base (concentrate).

21. Method according to claim 7, wherein the said cleaning medium at a concentration of 5 vol. % brings about a reduction of the microbial contamination by Enterococcus hirae exceeding 5 log counts within 30 seconds.
